(19) United States
(12) Patent Application Publication
(10) Pub. No.: US 2026/0259943 A1
(43) Pub. Date: Sep. 3, 2026

(54) SYSTEMS AND METHODS FOR AUTOMATICALLY HYPERLINKING TECHNICAL DOCUMENTATION FOR WORK INSTRUCTIONS

(71) Applicant: THE BOEING COMPANY, Arlington, VA (US)

(72) Inventor: Xiaoshan Pan, Atascadero, CA (US)

(73) Assignee: THE BOEING COMPANY, Arlington, VA (US)

(21) Appl. No.: 19/068,240

(22) Filed: Mar. 3, 2025

(51) Int. Cl. G06F 16/93; G06Q 10/067

(52) U.S. Cl. CPC G06F 16/94; G06Q 10/067

(57) ABSTRACT

A system and a method include a control unit configured to receive a work instruction, detect technical documentation within the work instruction, automatically find the technical documentation, as detected within the work instruction, within technical documentation data stored within one or more computerized technical sub-systems, and automatically generate a hyperlinked work instruction including one or more hyperlinks to the technical documentation stored within the one or more computerized technical sub-systems.

Examples of the present disclosure generally relate to systems and methods for automatically hyperlinking technical documentation for work instructions, such as in relation to maintenance, repair, and overhaul (MRO) work instructions for aircraft.

### BACKGROUND OF THE DISCLOSURE

Aircraft transport passengers and cargo between various locations. Numerous aircraft depart from and arrive at a typical airport every day.

Various components of an aircraft typically undergo maintenance, repair, and even overhaul over time. When performing maintenance, repair, and overhaul (“MRO”) on an aircraft, technicians follow detailed work instructions that contain specific technical data references. "AMM TASK 10-12-02-550-802" and "DWG 141A0650 (SH: 0191)" are examples of references within MRO work instructions. The references in an MRO work instruction point to particular sections within technical documentation, including an aircraft maintenance manual, an aircraft illustrated parts catalog, engineering drawings, flag notes, parts lists, and the like. Such technical documentation, however, is typically hosted across multiple, non-integrated computer systems. Consequently, during MRO procedures, technicians generally need to exit a work instruction system, and manually retrieve data from the various different computer systems. In particular, technicians manually log into each separate computer system to locate and retrieve technical data.

As can be appreciated, manually logging into each computer system and searching for relevant technical documentation is time and labor intensive, and typically requires a relatively high level of experience and skill to perform. Technicians typically require additional training and skills to efficiently gain access and interpret data across various computer systems.

Additionally, the aforementioned process is susceptible to outdated data. For example, to save time in relation to repeated data retrieval, technicians often print, bookmark, and/or store digital copies of the required technical information. However, as the computer systems that store the required technical documentation frequently update, the information previously saved or printed by technicians may be outdated.

Additionally, the aforementioned process can increase cognitive load for technicians. For example, moving between multiple systems to find technical data can disrupt focus, increase cognitive strain, and extend recovery time as technicians refocus on their tasks.

### SUMMARY OF THE DISCLOSURE

A need exists for an efficient and effective system and method for locating technical documentation references in work instructions, such as MRO work instructions for aircraft.

With that need in mind, certain examples of the present disclosure provide a system including a control unit configured to receive a work instruction, detect technical documentation within the work instruction, automatically find the technical documentation, as detected within the work instruction, within technical documentation data stored within one or more computerized technical sub-systems, and automatically generate a hyperlinked work instruction including one or more hyperlinks to the technical documentation stored within the one or more computerized technical sub-systems.

In at least one example, the system also includes a user interface including a display and an input device. The control unit is in communication with the user interface. The control unit is further configured to show the hyperlinked work instruction on the display. In at least one example, work instruction is configured to be input through the user interface, and the control unit is configured to receive the work instruction from the user interface.

In at least one example, the work instruction is a maintenance, repair, and overhaul (MRO) work instruction for an aircraft, and wherein the hyperlinked work instruction is a hyperlinked MRO work instruction.

In at least one example, the system includes the one or more computerized technical sub-systems. As a further example, the one or more computerized technical sub-systems include an aircraft maintenance manual, an aircraft illustrated parts catalog, engineering drawings, flag notes, and parts lists.

In at least one example, the system also includes a pattern database configured to store pattern data. The control unit is in communication with the pattern database. The control unit is configured to detect the technical documentation within the work instruction through the pattern data.

In at least one example, the one or more hyperlinks include one or more dynamic hyperlinks. As a further example, the control unit is configured to automatically generate the hyperlinked work instruction by, at least in part, encoding parameters into the one or more hyperlinks.

The system can also include a robot configured to perform one or more operations in relation to a component according to the hyperlinked work instruction.

The control unit can include an artificial neural network.

Certain examples of the present disclosure provide a method including receiving, by a control unit, a work instruction; detecting, by the control unit, technical documentation within the work instruction; automatically finding, by the control unit, the technical documentation, as detected within the work instruction, within technical documentation data stored within one or more computerized technical sub-systems; and automatically generating, by the control unit, a hyperlinked work instruction including one or more hyperlinks to the technical documentation stored within the one or more computerized technical sub-systems.

### BRIEF DESCRIPTION OF THE DRAWINGS

FIG. 1 illustrates a block diagram of a system, according to an example of the present disclosure.

FIG. 2 illustrates a simplified diagram of a robot operating on an aircraft, according to an example of the present disclosure.

FIG. 3 illustrates a flow chart of a method, according to an example of the present disclosure.

FIG. 4 illustrates a schematic block diagram of a control unit, according to an example of the present disclosure.

FIG. 5 illustrates a perspective front view of an aircraft, according to an example of the present disclosure.

The foregoing summary, as well as the following detailed description of certain examples will be better understood when read in conjunction with the appended drawings. As used herein, an element or step recited in the singular and preceded by the word "a" or "an" should be understood as not necessarily excluding the plural of the elements or steps. Further, references to "one example" are not intended to be interpreted as excluding the existence of additional examples that also incorporate the recited features. Moreover, unless explicitly stated to the contrary, examples "comprising" or "having" an element or a plurality of elements having a particular condition can include additional elements not having that condition.

Examples of the present disclosure provide automated systems and methods for quickly locating and accessing technical data referenced in work instructions, such as MRO work instructions for aircraft. As described herein, the systems and methods automatically scan work instructions to detect technical references, generate dynamic hyperlinks, and embed the hyperlinks in the work instructions. In this manner, technicians performing MRO work can quickly and easily access essential technical documentation, such as by engaging an input device of a user interface of a computer work station. As such, examples of the present disclosure (a) significantly reduce retrieval time of the technical information, (b) reduce the risk of outdated information being used, and (c) increase productivity by allowing technicians to focus tasks without switching between different computer systems.

Unlike prior processes in which technicians manually search different computer systems for information, examples of the present disclosure automate the search and retrieval of technical information within work instructions. In at least one example, the systems and methods include a control unit that generates dynamic hyperlinks using a pattern library, and application programming interface (API) specifications of computerized sub-systems where the technical documentation is stored.

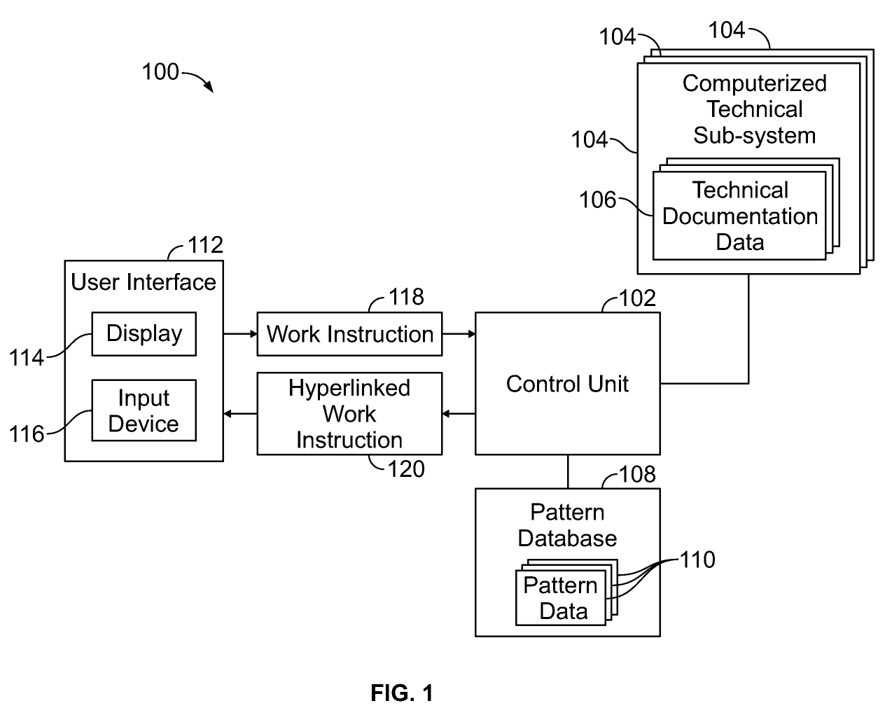

FIG. 1 illustrates a block diagram of a system 100, according to an example of the present disclosure. The system 100 includes a control unit 102 in communication with computerized technical sub-systems 104, such as through one or more wired or wireless connections. The control unit 102 can be co-located with one or more of the computerized technical sub-systems 104, or remotely located from the computerized technical sub-systems 104. The computerized technical sub-systems 104 store technical documentation data 106, such as within memories. Examples of the computerized technical sub-systems 104 include an aircraft maintenance manual, an aircraft illustrated parts catalog, engineering drawings, flag notes, parts lists, and the like. In at least one example, the control unit 102 is in communication with various different computerized technical sub-systems 104, such as the aircraft maintenance manual, the aircraft illustrated parts catalog, the engineering drawings, the flag notes, the parts list, each of which stores different technical documentation data 106.

The control unit 102 is also in communication with a pattern database 108, such as through one or more wired or wireless connections. The control unit 102 can be co-located with the pattern database 108, or remotely located from the pattern database 108. The pattern database 108 stores pattern data 110 regarding certain information of the technical documentation data 106. For example, the pattern data 110 includes titles, headings, or the like of particular information of the technical documentation data 106.

The control unit 102 is also in communication with a user interface 112, such as through one or more wired or wireless connections. The user interface 112 includes a display 114 and an input device 116. The display 114 can be a monitor, screen, television, touchscreen, and/or the like. The input device 116 can include a keyboard, mouse, stylus, touchscreen interface (that is, the input device 116 can be integral with the display 114), and/or the like. The user interface 112 can be, or part of, a computer workstation. As another example, the user interface 112 can be a handheld device, such as a smart phone, tablet, or the like.

In operation, the control unit 102 receives a work instruction 118. In at least one example, the work instruction 118 is included in an electronic signal that is received by the control unit 102. For example, the work instruction 118 can be input electronically through the input device 116 of the user interface 112, and electronically received by the control unit 102 through a wired or wireless connection between the control unit 102 and the user interface 112. As another example, the work instruction 118 is received from another device, such as another computer sub-system, a network, the Internet, or the like.

The work instruction 118 includes information regarding an operation to be performed in relation to a component. In at least one example, the component is an exterior or interior portion of an aircraft. For example, the component can be a flap of a wing, landing gear, an outer skin portion of a fuselage, an interior portion of the aircraft, such as a sink within a lavatory, or the like. As a further example, the work instruction 118 is a maintenance, repair, and overhaul (MRO) work instruction.

The work instruction 118 includes one or more references to technical documentation. As noted, the computerized technical sub-system 104 includes the technical documentation data 106, which includes the technical documentation. An example of the work instruction 118 is “Install Gang Channel(s) and Pate-Nuts as Required per DWG 65B00001, SHT 1, FN 11, GN 24, GN80, PS1900, STF 1706, PS11217 TYPE.” Such an example of the work instruction 118 includes technical documentation such as DWF 65B00001, PS1900, STF 1706, and PS11217, which can be stored in different computerized technical sub-systems 104. In the past, a technician would need to manually search the different computerized technical sub-systems 104 for such information.

As described herein, however, the control unit 102 receives the work instruction 118, and compares the work instruction 118 with the pattern data 110 in the pattern database 108. The pattern data 110 provides information regarding the technical documentation included within the work instruction 118. The control unit 102 matches information within the work instruction 118 with the pattern data 110 to extract the detected technical documentation within the work instruction 118. In at least one example, the control unit 102 includes or otherwise utilizes a pattern-matching engine that scans the work instruction 118 to detect valid technical documentation within the work instruction 118 based on the pattern data 110 within the pattern database 108. In at least one example, the pattern database 108 provides a pattern library, such as can be established by one or more individuals (for example, engineers) who authored the work instruction 118. The individual(s) define, refine, and update the pattern data 110 within the pattern database 108 to allow technical data references used in work instructions to be detected.

Next, the control unit 102 uses the detected technical documentation within the work instruction 118 to automatically search (without human intervention) the technical documentation data 106 and find matches therein. After finding the technical documentation within the technical documentation data 106 stored in the computerized technical sub-system(s) 104, the control unit 102 then automatically (without human intervention) generates hyperlinks for locations of the technical documentation located within the technical documentation data 106. For example, the control unit 102 automatically generates hyperlinks for DWF 65B00001, PS1900, STF 1706, and PS11217. After generating the hyperlinks, the control unit 102 then inserts the hyperlinks into the work instruction 118, to provide a hyperlinked work instruction 120 that includes the hyperlinks. For example, the control unit 102 indicates the hyperlinks within the work instruction 118 by underlining, highlighting, color differentiation, and/or the like. Using the example above, the hyperlinked work instruction 120 that is associated with the work instruction 118 is “Install Gang Channel(s) and Pate-Nuts as Required per DWG 65B00001, SHT 1, FN 11, GN 24, GN80, PS1900, STF 1706, PS11217 TYPE,” with the underlined portions indicating the hyperlinks. In at least one example, the control unit 102 automatically generates the hyperlinks based on pattern recognition and API specifications of the computerized technical sub-systems 104.

The control unit 102 outputs the hyperlinked work instruction 120 to the user interface 112, such as through the wired or wireless connection between the control unit 102 and the user interface 112. The control unit 102 automatically and electronically outputs the hyperlinked work instruction 120 to the user interface 112 without human intervention. The hyperlinked work instruction 120 is then shown on the display 114. For example, the control unit 102 operates the display 114 to electronically show the hyperlinked work instruction 120. A technician can then view the display 114, and select one or more of the hyperlinks within the hyperlinked work instruction 120, such as via the input device 116. Upon selection of a hyperlink, which includes the location of the technical documentation within the technical documentation data 106 stored within the computerized technical sub-system(s) 106, the control unit 102 automatically (without human intervention) retrieves the relevant technical documentation and shows the technical documentation on the display 114. In this manner, the technician does not need to manually search for relevant technical documentation with the computerized technical sub-systems 104. Instead, the control unit 102 automatically (without human intervention) retrieves the technical documentation for the technician.

As described herein, the control unit 102 automatically generates (without human intervention) the hyperlinked work instruction 120, which includes one or more hyperlinks. For example, the control unit 102 includes or otherwise utilizes a hyperlink generator that creates a unique hyperlink for valid technical documentation (for example, a valid technical reference), leveraging API specifications of the computerized technical sub-systems 104 where the technical documentation data 106 is stored. In response to the hyperlink being engaged by a technician (such as via the input device 116), the hyperlink issues an hypertext transfer protocol (HTTP) GET application programming interface (API) call to the computerized technical sub-system 104 where the technical documentation is stored within the technical documentation data 106, and then automatically retrieves the information therein. In at least one example, the hyperlinks are dynamic because they always point to the latest, most up-to-date versions of the technical documentation. The dynamic hyperlinks allow for retrieval of up-to-date, real-time data, thereby ensuring access to the most up-to-date information.

In at least one example, the control unit 102 inserts hyperlinks into text with proper formatting. For example, the control unit 102 includes, or otherwise utilizes a linkifier that inserts generated hyperlinks into original text following hypertext markup language (HTML) specifications.

In at least one example, the control unit 102 includes or otherwise uses a RESTful HTTP GET API, where parameters can be encoded in a hyperlink (in contrast to a POST API where parameters cannot be part of the link). The API implements a search operation that performs a real-time inquiry into a document repository to find the document that matches the criteria defined by the parameters encoded in the hyperlink. The API returns an HTML page, allowing a user to view the result directly. The HTML page also provides opportunities to further augment how the content of a search result can be presented to the technician.

Traditionally, a hyperlink is a web uniform resource locator (URL), which points to static content such as a picture, text document, or video file. In contrast, the control unit 102 generates dynamic hyperlinks. For example, the control unit 102 performs API calls to the computerized technical sub-systems 104 where the technical document(s) are hosted (such as stored within the technical documentation data 106), searches for the technical documentation, then shows it on the display 114, all of which occurs in a fraction of a second. Notably, a static link becomes obsolete when a newer version of the document is published, but a dynamic link does not. Instead, the dynamic link always retrieves the latest and most up-to-date version, thereby eliminating any potential for outdated information being used.

As described herein, the control unit 102 automatically scans the work instruction 118, identifies valid technical documentation therein by comparing with the pattern data 110 in the pattern database 108, and generates the hyperlinked work instruction 120 without human intervention, and thereby allows a technician to quickly and easily gain access to (such as via the user interface 112) the relevant technical documentation stored within the computerized technical sub-system(s) 104. As such, examples of the present disclosure allow for quick and easy retrieval of the technical documentation and eliminate, minimize, or otherwise reduce manual data retrieval.

As described herein, the system 100 includes the control unit 102, which is configured to receive the work instruction 118, detect technical documentation within the work instruction 118, automatically find the technical documentation, as detected within the work instruction 118, within the technical documentation data 106 stored within one or more computerized technical sub-systems 104, and automatically generate the hyperlinked work instruction 120 including one or more hyperlinks to the technical documentation stored within the one or more computerized technical sub-systems 104. In at least one example, the system 100 also includes the user interface 112, which includes the display 114 and the input device 116. The control unit 102 is in communication with the user interface 112. The control unit 102 is further configured to show the hyperlinked work instruction 118 on the display 114.

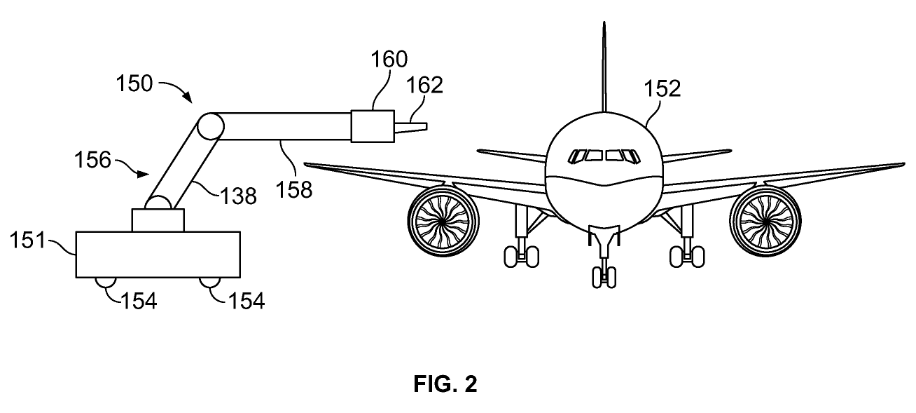

FIG. 2 illustrates a simplified diagram of a robot 150 operating on an aircraft 152, according to an example of the present disclosure. The robot 150 is configured to operate on one or more exterior or interior components of the aircraft 152. For example, the robot 150 is configured to perform operations on a fuselage, wing, or the like of the aircraft 152.

The robot 150 includes a platform 151, such as a base having one or more retaining walls, a housing, and/or the like. One or more conveyors 154 extend downwardly from the platform 151. Examples of the conveyors 154 include wheels (such as powered and/or unpowered wheels), casters, a wheeled track, moveable legs, and/or the like. Optionally, the robot 150 may not include conveyors 154. For example, the platform 151 can be stationary.

The robot 150 also includes a positioner 156. In at least one example, the positioner 156 is or otherwise includes one or more arms 158. For example, multiple articulated arms 158 can be coupled together through one more movable joints. One or more actuators, such as motors, are operatively coupled to the arm(s) 158. The actuators are configured to automatically move the arm(s) 158. The platform 151 supports the arm(s) 158 and the actuator(s). As another example, the positioner can be or include one or more gantries, one or more flex tracks, one or more tracks, one or more telescoping members, and/or the like.

An end effector 160 is coupled to a distal end of the arm(s) 158. The end effector 160 retains a tool 162. In at least one example, the tool 162 is an automated drill, such as a power feed drill. As another example, the tool 162 can be a cutting tool, such as an automated reciprocating saw. As another example, the tool 162 can be an automated driver, rivet gun, or the like. As another example, the tool 162 can be a laser device configured to form holes through emitted laser energy. As another example, the tool 162 can be an inspection tool, such as a hole probe.

Referring to FIGS. 1 and 2, in at least one example, the control unit 102 is configured to control operation of the robot 150 to perform one or more operations (such as MRO operations) in relation to the aircraft 152. In at least one example, the control unit 102 automatically controls the robot 150 to perform one or more operations in relation to the aircraft according to the hyperlinked work instruction 120. Optionally, the control unit 102 may not automatically operate the robot 150. Also, optionally, the robot 150 may not be used to perform operations according to the hyperlinked work instruction 120.

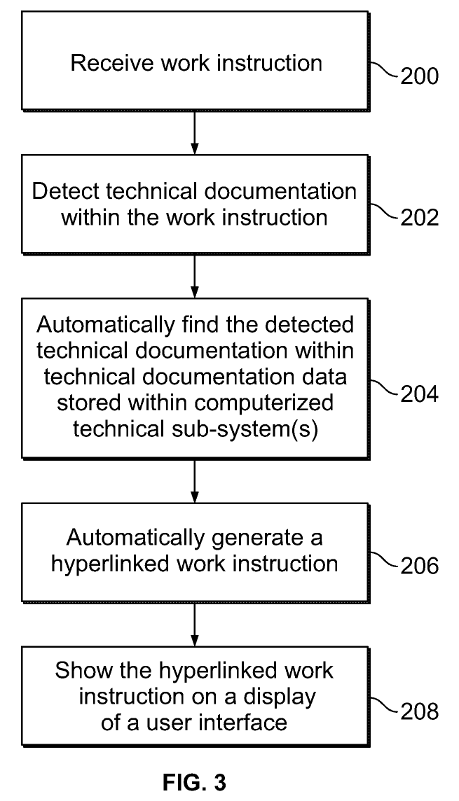

FIG. 3 illustrates a flow chart of a method, according to an example of the present disclosure. Referring to FIGS. 1 and 3, at 200, the control unit 102 receives the work instruction 118, such as from the user interface 112. At 202, the control unit 102 detects technical documentation within the work instruction 118, such as through comparison with the pattern data 110 within the pattern database 108. At 204, the control unit 102 automatically finds the technical documentation, as detected, within the technical documentation data 106 stored in one or more computerized technical sub-systems 104. At 206, the control unit 102 then automatically generates the hyperlinked work instruction 120, which includes hyperlinks to the technical documentation stored within the technical documentation data 106. At 208, the control unit 102 shows the hyperlinked work instruction 120 on the display 114 of the user interface 112.

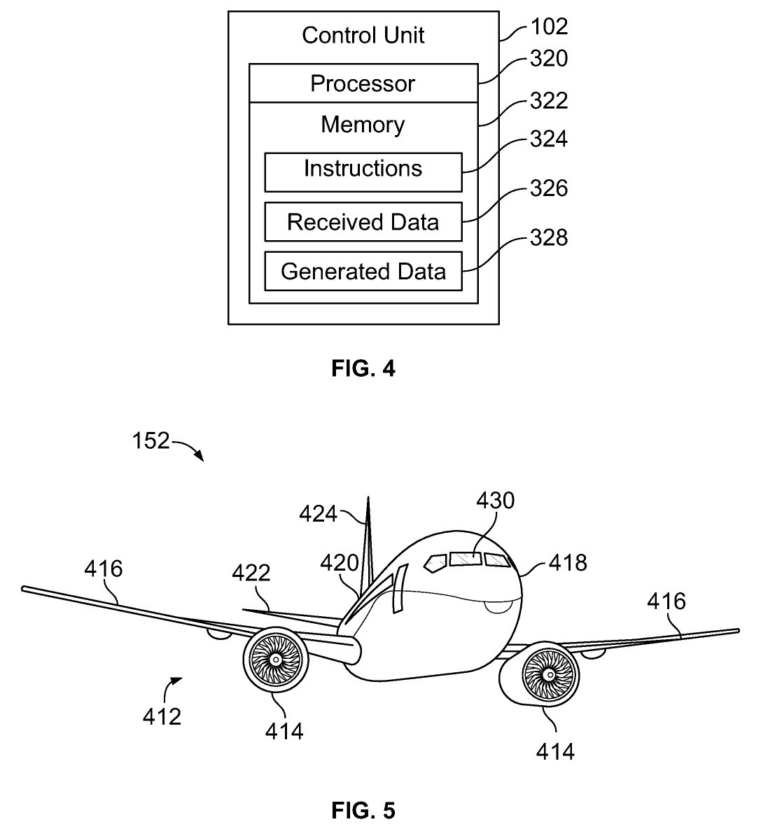

FIG. 4 illustrates a schematic block diagram of the control unit 102, according to an example of the present disclosure. In at least one example, the control unit 102 includes at least one processor 320 in communication with a memory 322. The memory 322 stores instructions 324, received data 326, and generated data 328. The control unit 102 shown in FIG. 4 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-4, examples of the subject disclosure provide systems and methods that allow large amounts of data to be quickly and efficiently analyzed by a computing device. For example, the control unit 102 analyzes work instructions 118, searches data within the computerized technical sub-systems 104, and generates hyperlinked work instructions 120. As such, large amounts of data, which may not be readily discernable by human beings, are being tracked and analyzed. The vast amounts of data are efficiently organized and/or analyzed by the control unit 102, as described herein. The control unit 102 analyzes the data in a relatively short time in order to automatically (without human intervention), quickly. and efficiently detect technical documentation, search and find such information within the computerized technical sub-systems 104, and generate associated hyperlinked work instructions 120. As such, examples of the present disclosure provide increased and efficient functionality, and vastly superior performance in relation to a human being analyzing the vast amounts of data.

In at least one example, components of the system 100, such as the control unit 102, provide and/or enable a computer system to operate as a special computer system for generating hyperlinked work instructions 120. The control unit 102 improves upon standard computing devices by providing such hyperlinked work instructions 120 in an efficient and effective manner.

In at least one example, all or part of the systems and methods described herein may be or otherwise include an artificial intelligence (AI) or machine-learning system that can automatically perform the operations of the methods also described herein. For example, the control unit 102 can be an artificial intelligence or machine learning system. These types of systems may be trained from outside information and/or self-trained to repeatedly improve the accuracy with how data is analyzed to find technical documentation and generated hyperlinked work instructions 120. Over time, these systems can improve by determining and communicating with increasing accuracy and speed, thereby significantly reducing the likelihood of any potential errors. For example, the AI or machine-learning systems can learn and determine models, and associate such models with technical documentation/references, and generation of hyperlinks. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determinations and communications described herein. The training minimizes conflicts and interference by performing an iterative training algorithm, in which the systems are retrained with an updated set of data, and based on the feedback examined prior to the most recent training of the systems. This provides a robust analysis model that can better find technical documentation and generate hyperlinked work instructions 120 in an extremely fast, cost effective, and efficient manner. Machine learning can be used in relation to technical data reference pattern detection, finding and matching of information, and automation, for example.

In one example, the control unit 102 includes or represents an artificial neural network (ANN) that identifies patterns in the visual, vectoral, or vector space representations of data, classifies the patterns (e.g., assigns a class to an identified pattern, such as class #1, class #2, and so on) based on the contents of the patterns that are identified, and identifies records (for example, documents) based on the classifications. Usage of a specially trained ANN to identify records in this way provides improvements over traditional methods of finding technical documentation, including more accurate identification of the relevant information on a much larger scale than is possible with humans identifying the information, and identification of the events much faster and/or at a much more rapid frequency than is possible with humans. The ANN can be realized through software, hardware, or a combination of software and hardware. The structure of the ANN can be a series of layers, with each layer including one or more artificial neurons arranged in one or more neuron arrays. Each of these neurons may include or represent a register, a microprocessor, and at least one input. Each neuron can produce an output, or activation, based on an activation function that uses the outputs of the previous layer and a set of weights as inputs. Each neuron in a neuron array can be connected to another neuron in the same layer or in another layer via one or more synaptic circuits. A synaptic circuit may include a memory for storing a synaptic weight. One example of this ANN may be a deep neural network having an input layer, an output layer, and a plurality of fully connected hidden layers. In some examples, the ANN (e.g., the control unit 102) can be implemented by an application-specific integrated circuit (ASIC) specially customized for the specific artificial intelligence application described herein and provide superior computing capabilities and reduced electricity consumption compared to traditional computers.

Training data can be generated by receiving continuous data at the control unit 102 and using the control unit 102 to discretize the continuous data. Optionally, the control unit 102 can be trained with a pretrained model. The training data or pretrained model may be received by the control unit 102 remotely over one or more networks. The training data may be historical data, which the neural network can use to learn patterns in the visual representations of the data to identify or detect the same (or similar) patterns in other data. The trained ANN monitors additional visual representations of data to identify patterns and classify the patterns. If the trained ANN detects one or more patterns, the trained ANN can classify the pattern(s) to generate classification data which can be output to a user and/or used to re-train the ANN.

The ANN of the control unit 102 can continue to learn to improve identification of patterns in data visualizations, as well as improve the classification of the identified patterns. This continued learning can occur by, for example, changing the output generated by one or more of the neurons responsive to receiving the same input (e.g., a neuron produces a different output after the change), changing the activation function of one or more neurons, changing one or more of the weights, and/or changing one or more of the connections between the neurons (or which neurons are connected with each other). Changing one or more of these factors can cause the ANN to produce a different output (e.g., a different pattern is identified and/or a different classification is selected) than prior to the change.

FIG. 5 illustrates a perspective front view of an aircraft 152, according to an example of the present disclosure. The aircraft 152 includes a propulsion system 412 that includes engines 414, for example. Optionally, the propulsion system 412 may include more engines 414 than shown. The engines 414 are carried by wings 416 of the aircraft 152. In other examples, the engines 414 may be carried by a fuselage 418 and/or an empennage 420. The empennage 420 may also support horizontal stabilizers 422 and a vertical stabilizer 424. The fuselage 418 of the aircraft 152 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like.

FIG. 5 shows an example of an aircraft 152. It is to be understood that the aircraft 152 can be sized, shaped, and configured differently than shown in FIG. 5. Optionally, examples of the present disclosure can be used with various other types of vehicles, such as land-based vehicles (for example, automobiles, buses, locomotives, etc.), watercraft, spacecraft, or the like. Additionally, examples of the present disclosure can be used with fixed structures (such as commercial or residential buildings), appliances, electronic systems, or the like.

Further, the disclosure comprises examples according to the following clauses:

Clause 1. A system comprising:

a control unit configured to:

receive a work instruction,

detect technical documentation within the work instruction,

automatically find the technical documentation, as detected within the work instruction, within technical documentation data stored within one or more computerized technical sub-systems, and

automatically generate a hyperlinked work instruction including one or more hyperlinks to the technical documentation stored within the one or more computerized technical sub-systems.

Clause 2. The system of Clause 1, further comprising a user interface comprising a display and an input device, wherein the control unit is in communication with the user interface, and wherein the control unit is further configured to show the hyperlinked work instruction on the display.

Clause 3. The system of Clause 2, wherein the work instruction is configured to be input through the user interface, and wherein the control unit is configured to receive the work instruction from the user interface.

Clause 4. The system of any of Clauses 1-3, wherein the work instruction is a maintenance, repair, and overhaul (MRO) work instruction for an aircraft, and wherein the hyperlinked work instruction is a hyperlinked MRO work instruction.

Clause 5. The system of any of Clauses 1-4, further comprising the one or more computerized technical sub-systems.

Clause 6. The system of Clause 5, wherein the one or more computerized technical sub-systems comprise an aircraft maintenance manual, an aircraft illustrated parts catalog, engineering drawings, flag notes, and parts lists.

Clause 7. The system of any of Clauses 1-6, further comprising a pattern database configured to store pattern data, wherein the control unit is in communication with the pattern database, and wherein the control unit is configured to detect the technical documentation within the work instruction through the pattern data.

Clause 8. The system of any of Clauses 1-7, wherein the one or more hyperlinks comprise one or more dynamic hyperlinks.

Clause 9. The system of any of Clauses 1-8, wherein the control unit is configured to automatically generate the hyperlinked work instruction by, at least in part, encoding parameters into the one or more hyperlinks.

Clause 10. The system of any of Clauses 1-9, further comprising a robot, wherein the robot is configured to perform one or more operations in relation to a component according to the hyperlinked work instruction.

Clause 11. The system of any of Clauses 1-10, wherein the control unit comprises an artificial neural network.

Clause 12. A method comprising:

receiving, by a control unit, a work instruction,

detecting, by the control unit, technical documentation within the work instruction,

automatically finding, by the control unit, the technical documentation, as detected within the work instruction, within technical documentation data stored within one or more computerized technical sub-systems, and

Clause 13. The method of Clause 12, further comprising showing, by the control unit, the hyperlinked work instruction a display of a user interface.

Clause 14. The method of Clause 13, further comprising inputting, the through the user interface, the work instruction, and wherein said receiving comprises receiving the work instruction from the user interface.

Clause 15. The method of any of Clauses 12-14, wherein the work instruction is a maintenance, repair, and overhaul (MRO) work instruction for an aircraft, and wherein the hyperlinked work instruction is a hyperlinked MRO work instruction.

Clause 16. The method of any of Clauses 12-15, wherein the one or more computerized technical sub-systems comprise an aircraft maintenance manual, an aircraft illustrated parts catalog, engineering drawings, flag notes, and parts lists.

Clause 17. The method of any of Clauses 12-16, wherein said detecting comprises detecting the technical documentation within the work instruction through pattern data stored within a pattern database.

Clause 18. The method of any of Clauses 12-17, wherein the one or more hyperlinks comprise one or more dynamic hyperlinks, and wherein said automatically generating comprises encoding parameters into the one or more hyperlinks.

Clause 19. The method of any of Clauses 12-18, further comprising performing, by a robot, one or more operations in relation to a component according to the hyperlinked work instruction.

Clause 20. A system comprising:

a user interface comprising a display and an input device;

one or more computerized technical sub-systems configured to store technical documentation data;

a pattern database configured to store pattern data; and

a control unit in communication with the user interface, the one or more computerizing technical sub-systems, and the pattern database, wherein the control unit is configured to:

receive a work instruction from the user interface,

detect technical documentation within the work instruction through the pattern data,

automatically find the technical documentation, as detected within the work instruction, within the technical documentation data stored within the one or more computerized technical sub-systems,

automatically generate a hyperlinked work instruction including one or more dynamic hyperlinks to the technical documentation stored within the one or more computerized technical sub-systems, wherein the control unit is configured to automatically generate the hyperlinked work instruction by, at least in part, encoding parameters into the one or more hyperlinks, and

show the hyperlinked work instruction on the display of the user interface.

As described herein, examples of the present disclosure provide efficient and effective systems and methods for locating technical documentation references in work instructions, such as MRO work instructions for aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
an aircraft; and
a control unit including one or more processors configured to: receive a maintenance, repair, and overhaul (MRO) work instruction for the aircraft, wherein the MRO work instruction includes information regarding one or more operations to be performed in relation to one or more components of the aircraft, detect technical documentation within the MRO work instruction, automatically find the technical documentation, as detected within the MRO work instruction, within technical documentation data stored within one or more computerized technical sub-systems including an aircraft maintenance manual, an aircraft illustrated parts catalog, engineering drawings, flag notes, and parts lists, and automatically generate a hyperlinked MRO work instruction including one or more hyperlinks to the technical documentation stored within the one or more computerized technical sub-systems,
wherein the one or more operations are configured to be performed in relation to the one or more components of the aircraft according to the hyperlinked MRO work instruction.

2. The system of claim 1, further comprising a user interface comprising a display and an input device, wherein the control unit is in communication with the user interface, and wherein the control unit is further configured to show the hyperlinked MRO work instruction on the display.

3. The system of claim 2, wherein the MRO work instruction is configured to be input through the user interface, and wherein the control unit is configured to receive the MRO work instruction from the user interface.

4. (canceled)

5. The system of claim 1, further comprising the one or more computerized technical sub-systems.

6. (canceled)

7. The system of claim 1, further comprising a pattern database configured to store pattern data, wherein the control unit is in communication with the pattern database, and wherein the control unit is configured to detect the technical documentation within the MRO work instruction through the pattern data.

8. The system of claim 1, wherein the one or more hyperlinks comprise one or more dynamic hyperlinks.

9. The system of claim 1, wherein the control unit is configured to automatically generate the hyperlinked MRO work instruction by, at least in part, encoding parameters into the one or more hyperlinks.

10. The system of claim 1, further comprising a robot, wherein the robot is configured to perform the one or more operations in relation to the one or more components according to the hyperlinked MRO work instruction, wherein the robot comprises:
a platform;
one or more conveyors;
a positioner including articulated arms coupled together through movable joints;
one or more actuators coupled to the articulated arms;
an end effector coupled to a distal end of the articulated arms; and
a tool retained by the end effector.

11. The system of claim 1, wherein the control unit comprises an artificial neural network.

12. A method comprising:
receiving, by a control unit including one or more processors, a maintenance, repair, and overhaul (MRO)work instruction for the aircraft, wherein the MRO work instruction includes information regarding one or more operations to be performed in relation to one or more components of the aircraft;
detecting, by the control unit, technical documentation within the MRO work instruction;
automatically finding, by the control unit, the technical documentation, as detected within the MRO work instruction, within technical documentation data stored within one or more computerized technical sub-systems including an aircraft maintenance manual, an aircraft illustrated parts catalog, engineering drawings, flag notes, and parts lists; and
automatically generating, by the control unit, a hyperlinked MRO work instruction including one or more hyperlinks to the technical documentation stored within the one or more computerized technical sub-systems; and
performing the one or more operations in relation to the one or more components of the aircraft according to the hyperlinked MRO work instruction.

13. The method of claim 12, further comprising showing, by the control unit, the hyperlinked MRO work instruction a display of a user interface.

14. The method of claim 13, further comprising inputting, the through the user interface, the MRO work instruction, and wherein said receiving comprises receiving the MRO work instruction from the user interface.

15. (canceled)

16. (canceled)

17. The method of claim 12, wherein said detecting comprises detecting the technical documentation within the MRO work instruction through pattern data stored within a pattern database.

18. The method of claim 12, wherein the one or more hyperlinks comprise one or more dynamic hyperlinks, and wherein said automatically generating comprises encoding parameters into the one or more hyperlinks.

19. The method of claim 12, further comprising performing, by a robot, one or more operations in relation to a component according to the hyperlinked MRO work instruction, wherein the robot comprises:
a platform;
one or more conveyors;
a positioner including articulated arms coupled together through movable joints;
one or more actuators coupled to the articulated arms;
an end effector coupled to a distal end of the articulated arms; and
a tool retained by the end effector.

20. A system comprising:
an aircraft;
a user interface comprising a display and an input device;
one or more computerized technical sub-systems configured to store technical documentation data, wherein the one or more computerized technical sub-systems include an aircraft maintenance manual, an aircraft illustrated parts catalog, engineering drawings, flag notes, and parts lists;
a pattern database configured to store pattern data; and
a control unit including one or more processors in communication with the user interface, the one or more computerizing technical sub-systems, and the pattern database, wherein the control unit is configured to:receive a maintenance, repair, and overall (MRO) work instruction from the user interface, wherein the MRO work instruction includes information regarding one or more operations to be performed in relation to one or more components of the aircraft detect technical documentation within the MRO work instruction through the pattern data,automatically find the technical documentation, as detected within the MRO work instruction, within the technical documentation data stored within the one or more computerized technical sub-systems,automatically generate a hyperlinked MRO work instruction including one or more dynamic hyperlinks to the technical documentation stored within the one or more computerized technical sub-systems, wherein the control unit is configured to automatically generate the hyperlinked MRO work instruction by, at least in part,
encoding parameters into the one or more hyperlinks, andshow the hyperlinked MRO work instruction on the display of the user interface,wherein the one or more operations are configured to be performed in relation to the one or more components of the aircraft according to the hyperlinked MRO work instruction.

21. The system of claim 8, wherein the control unit is further configured to:
perform application programming interface (API) calls to the one or more computerized technical sub-systems,
search for the technical documentation data stored within the one or more computerized technical sub-systems, and generate the one more dynamic MRO hyperlinks, wherein the one or more MRO hyperlinks are configured to retrieve a latest, most up-to- date version of the technical documentation data.

22. The system of claim 10, wherein the control unit is further configured to automatically control operation of the robot to perform the one or more operations in relation to the one or more components according to the hyperlinked MRO work instruction.

23. The method of claim 18, further comprising:
performing, by the control unit, application programming interface (API) calls to the one or more computerized technical sub-systems,
searching, by the control unit, for the technical documentation data stored within the one or more computerized technical sub-systems, and
generating, by the control unit, the one more dynamic MRO hyperlinks,
wherein the one or more MRO hyperlinks are configured to retrieve a latest, most up-to- date version of the technical documentation data.

24. The method of claim 19, wherein said performing comprises automatically controlling, by the control unit, operation of the robot.
